(19) United States
(12) Patent Application Publication
(10) Pub. No.: US 2008/0059386 A1
(43) Pub. Date: Mar. 6, 2008

(54) System and method for contact device dynamic downloads

(76) Inventors: Michael L. Howard, Austin, TX (US); Andrew M. Browder, Lakeway, TX (US); John A. Lehr, Round Rock, TX (US)

Correspondence Address: HAMILTON & TERRILE, LLP, P.O. BOX 203518, AUSTIN, TX, 78720, US

(21) Appl. No.: 11/469,117

(22) Filed: Aug. 31, 2006

(51) Int. Cl. G06F 17/00

(52) U.S. Cl. 705/404

(57) ABSTRACT

Modeled contact results for contact attempts to plural accounts using plural contact treatments are applied to optimize the contact treatments used to contact the accounts. Plural objective functions solved by a goals programming formulation include the number of accounts to manage through a predetermined contact treatment, such as telephone communication treatment. Contact results from the contact treatment are fed back to re-optimize accounts for additional contact attempts. Optimization of the number of accounts downloaded for telephone communication treatment improves utilization of contact resources, such as contact device utilization.

### BACKGROUND OF THE INVENTION

1. Field of the Invention

The present invention relates in general to the field of contact devices, and more particularly to a system and method for contact device with dynamic inventory management downloads.

2. Description of the Related Art

Contact devices, such as automated dialers, have greatly improved the efficiency with which business enterprises manage customer relations. Predictive dialers support outbound telephone contacts for a plurality of agents by automatically dialing telephone numbers and interfacing the agents with contacts as outbound calls are answered by contacts. The predictive dialer dials outbound contacts at a rate predicted to keep contacts available for the agents to handle as the agents become available. Contact devices sometimes include the ability to manage both inbound contacts and outbound contacts by selectively interfacing agents with contacts placed into the dialer as well as contacts dialed out from the dialer. Often a contact center will have plural dialers, each with a set of associated agents, which operate in a coordinated fashion. Contact devices generally support interfaces with contacts through a variety of contact media including the PSTN, VoIP, e-mail, instant messaging or facsimile devices.

One common use of contact devices is to contact customers who owe money for collection of the money. In some instances, customers forget to pay so that a reminder telephone contact results in payment. However, some customers are offended by collection contacts resulting in greater payment delays or, worse, closing of the account by the customer. In some instances, customers have run into financial difficulties and are unable to pay. In such instances, a preemptive contact of the customer by the agent allows the customer to work out a payment plan for the benefit of both the customer and the enterprise. In other instances, customers are unable and unwilling to pay so that a preemptive contact of the customer by the agent allows the enterprise to close the account before the customer's debt increases. Contact center managers thus face complex choices in deciding whether and how to manage contacts with customers. Further complexity is added by the nature of the contact accounts themselves. For example, each account has varying debts and delinquencies to consider as well as varying probability of getting a successful contact with the individual customer responsible for the account. Contact device resources are expensive and typically limited so that varying strategies for the use of contact resources will have varying efficiencies.

One technique used by contact centers for improving the efficiency provided by contact resources is a statistical approach known as optimization. For example, Austin Logistics Incorporated (ALI) offers CALLTECH, an application that use optimization to predict if contacts will respond to a contact attempt to determine a best time to make a contact attempt. The ALI ACTIONSELECT application applies optimization to select a best contact treatment for attempting a contact, such as a telephone call, an e-mail or a letter sent to the contact. ACTIONSELECT optimizes for a variable selected by the contact center, such as optimal collections in terms of dollars, optimal collection in terms of delinquencies or optimal collections for a number of accounts. One difficulty with optimizing actions is that the cost and availability of contact media are difficult to quantify in a meaningful way, particularly as a contact campaign progresses. Although the optimization may provide an optimal objective function solution for a contact campaign with a given set of contacts for given constraints, the solution suggested by the optimization may be unachievable for available contact resources.

### SUMMARY OF THE INVENTION

Therefore a need has arisen for a system and method which factors limited contact resources for optimization of the selection of contact media to attempt contacts.

A further need exists for a system and method that manages action selection for contacts through plural media as contact attempts progress.

In accordance with the present invention, a system and method are provided which substantially reduce the disadvantages and problems associated with previous methods and systems for optimization of action selections for attempting contacts through plural media. A goals programming formulation supports optimization of plural objectives, including optimization of distribution of accounts for contacting to a plurality of contact treatments.

More specifically, a contact optimizer applies a goals programming formulation to optimize multiple objective functions for performing contacts to accounts. Models provided by a modeling module predict contact results for contact attempts to accounts using plural contact treatments. An account inventory estimator and an optimizer module cooperate to apply a goals programming formulation that optimizes the distribution of accounts to contact treatments for achieving a desired business objective. The optimal account contact treatment assignments are used to perform contact attempts through the plural content treatments and the contact results are monitored. Contact results are applied as feedback to re-optimize the account population for distribution to contact treatments and subsequent contact attempts.

The present invention provides a number of important technical advantages. One example of an important technical advantage is that increased precision and business effectiveness is provided for the constraints and optimization. The goals programming formulation allows consideration of a set of complex constraint, some sub-sets of the full constraint set with and some without a feasible solution; however, the solutions can be prioritized such that they are completely or closely satisfied according to the ordinal value of the respective weights assigned to represent their business value. Dynamic constraint updates provided through monitoring of contact results by contact treatments allows updating of the remaining contact account inventory for changes in strategy, input population or other factors to preserve the effectiveness of the constraints and subsequent solution. Optimizing the distribution of contact accounts to contact treatments improves contact results and contact device resource utilization, such as utilization of more expensive treatments like telephone communication treatments.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for optimizing contact attempts through plural contact treatments;

FIG. 2 shows a flow diagram of a process for optimizing contact attempts through plural contact treatments.

### DETAILED DESCRIPTION

Management of contact attempts to contact accounts presents a complex problem for effective use of contact resources, particularly where plural contact treatments are available to perform the contact attempts. A contact optimizer optimizes contact treatments for a set of accounts by determining the best mix of considered actions in order to maximize desired objectives over the account set population. The contact optimizer also determines the most effective treatment for each account based on the overall expected portfolio performance in support of the desired objectives. For example, a goals programming formulation solves for a business objective, such as maximized revenue or minimized cost, and a contact treatment objective, such as the number of accounts to manage through a particular contact treatment, like download to a dialer for telephone contact treatment. This methodology empirically derives the relationship between a contact treatment and an average inventory contribution for that contact treatment, which changes based upon the population profile and other constraints imposed in a contact campaign over time. Contact results for contact attempts are therefore monitored to update the population profile and model to maintain the effectiveness of the optimized solution, essentially creating a closed loop system with feedback. In alternative embodiments, other more general objective functions may be maximized, such as a compound objective composed of a plurality of predictions which intend to provide an economic value as a function of unique treatments.

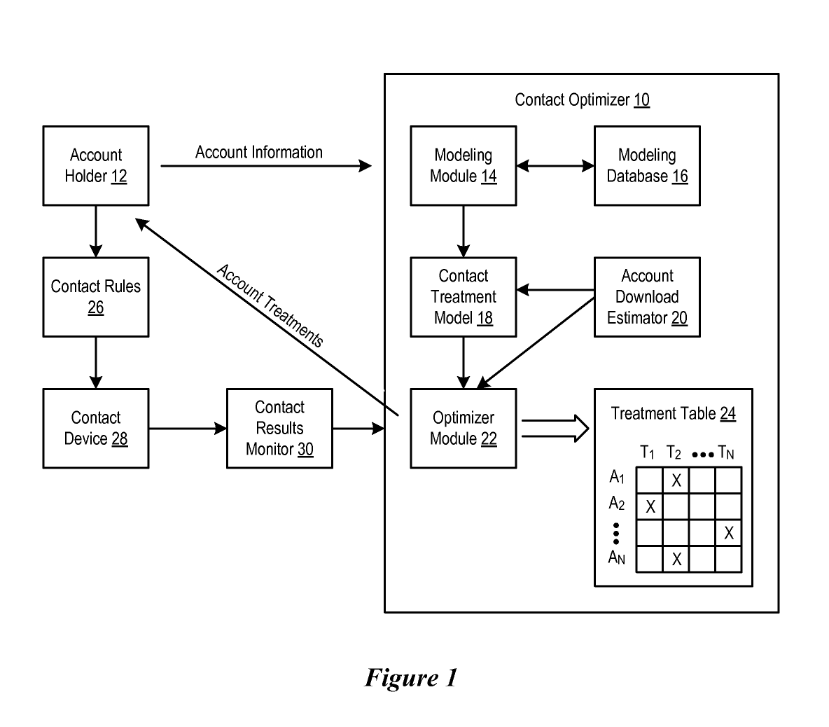

Referring now to FIG. 1, a block diagram depicts a system for optimizing contact attempts through plural contact treatments. A contact optimizer 10 receives account information from an account holder 12 and applies the account information to build an optimized contact strategy for contacting the accounts. Contact optimizer 10 has a modeling module 14 that analyzes account information from a modeling database 16 to generate models that predict contact results for contact attempts based on the account information received from account holder 12. In particular, modeling module 14 generates a contact treatment model 18 that predicts contact results based upon the type of contact treatment used to perform a contact attempt, such as contact results for telephone communication treatment, like an automated POTS or VoIP dialer, electronic written communication treatment, like e-mail or instant messages, physical written correspondence treatment, like letters sent through mail, or delayed treatment, like a delay in performing the contact attempt to allow self-cure of the account. An account download estimator 20 applies contact treatment model 18 to determine a preferred distribution of contact treatments for the accounts, such as the number of accounts to place in inventory for a contact device for telephone communication contact treatment. An optimizer module 22 performs an optimization using models provided by modeling module 14 and the contact results predicted by the contact treatment distribution of contact treatment model 18 to assign a treatment to each account as depicted by treatment table 24. For example, optimizer module 22 applies a goals programming formulation to estimate an optimal treatment for each account based on a business objective function and an objective function for the number of accounts downloaded for telephone communication treatment.

Once an optimal contact treatment distribution is assigned to the account information provided by account holder 12, account treatment information is provided from optimizer module 22 to account holder 12 to initiate contact attempts. Account holder 12 applies contact rules 26 to initiate contact attempts, such as defined times to attempt telephone communication. The accounts are forwarded to one or more contact devices 28 so that actual contact attempts are performed, such as telephone calls dialed to telephone numbers of the account information. A contact results monitor 30 monitors the results of the contact attempts, such as a successful or unsuccessful contact attempt or a successful or unsuccessful business objective. The contact results are forwarded to contact optimizer 10 to update modeling database 16 for providing more effective predicted results and to optimizer module 22 so that the population profile of the accounts in need of treatment reflects the results of the contact attempts. Optimizer module 22 re-optimizes the updated account population for selected business objectives and the number of accounts to subject to telephone contact treatment. The re-optimized account treatments are then provided to account holder 12 to continue the contact campaign.

One example of a business scenario that uses optimization to improve contact effectiveness is a scenario in which a business seeks to contact accounts that owe money to collect the money from the individual responsible for the account. Using this scenario as an example to explain the optimization process with a goals programming formulation, plural objective functions may be selected for optimization, such as: a maximum cure rate; maximum balance weighted cures; minimum total cost represented by a cost for each available action times the number of actions to be performed; maximum net revenue represented by the balance for each account times the probability of a cure minus the cost of each action; maximizing net back or collection yield; and the average daily download for a predetermined treatment, such as a telephone communication treatment. The objectives and constraints are applied to a non-preemptive goals programming framework to generate a matrix of accounts A and treatments T depicted by treatment table 24 with the assumption that each account is assigned to one of plural available treatments. Treatment table 24 represents decision variables in a matrix x where x(i,j) is one if the account A (labeled i) is assigned a treatment T (labeled j) and zero if the account A is not assigned the treatment T. A goal g is assumed as a linear function of the decision variables:

$$g ( x ) = {\sum }_{i} {\sum }_{j} γ ( i , j ) x ( i , j )$$

A target value G is assumed within the range of g so that the goal sought for g is to approach G as near as possible by the choice of x, where G is a lower bound goal or an upper bound goal. Within the context of meeting any constraints or other goals:

z(x)=g(x)−G

z⁺(x)=z(x) if z(x)≧0,

z⁺(x)=0 otherwise

z⁻(x)=−z(x) if z(x)<0,

z⁻(x)=0 otherwise

where z+ and z− are the positive and negative components of z so that:

z(x)=z⁺(x)−z⁻(x)

and the goal for the value of G is minimizing z+(x) for a lower bound and z−(x) for an upper bound. To provide linear objective functions, z+ and z− are transformed to an equivalent linear form by the introduction of auxiliary variables so that the lower bound is defined by:

minimize z^{←} [lower bound goal]

subject to the constraints

z(x)−(z^{→}−z^{←})=0

z^{→}≧0

z^{←}≧0

The upper bound z+ is defined by the same constraints as the lower bound, allowing the general form of the objective function with P distinct goals for the non-preemptive goals programming to be described by:

z_{K}(x)=g_{K}(x)−G_{K}, K=1, . . . ,P

For each K, the auxiliary variables are created to provide linearity so that the equality constraints are:

z_{K}(x)−(z_{K}^{→}−z_{K}^{←})=0

z_{K}^{→}≧0

z_{K}^{←}≧0

Each goal K has an associated weight W based on the relative importance of the goal so that the combined objective for the plural goals is to:

minimize Σ_{K}w_{K}z_{K}

while meeting the equality constraints for each K and any predefined hard non-goal constraints. A lower and upper bound goal may be associated with the same g function with the g function appearing twice.

Objective functions are solved as lower or upper bound goals by making the value of a g function as large or as small as possible using a pre-defined target value G. A value for G is computed within the above goals programming framework to determine optimal minimum or maximum values. To maximize an objective g, G is determined by optimization subject to any hard constraints by choosing x from:

j′(i)=argmax(γ(i,j), j=1, . . . ,T), i=1, . . . ,A

x(i, j′(i))=1, x(i,j)=0 if j≠j′(i), i=1, . . . ,A

with g(x) for the choice of x providing the defined maximum. If the objective is to minimize g then G is determined by optimization subject to any hard constraints by choosing x from:

j′(i)=argmin(γ(i,j), j=1, . . . ,T), i=1, . . . ,A

x(i, j′(i))=1, x(i,j)=0 if j≠j′(i), i=1, . . . ,A

with g(x) for the choice of x providing the defined minimum. An example of a hard constraint is the constraint that each account gets only one treatment, expressed by:

x(i,1)+x(i,2)+ . . . +x(i,T)=1, i=1, . . . ,A

### The goals are appropriately rescaled to allow correct interpretation when the respective weights are applied.

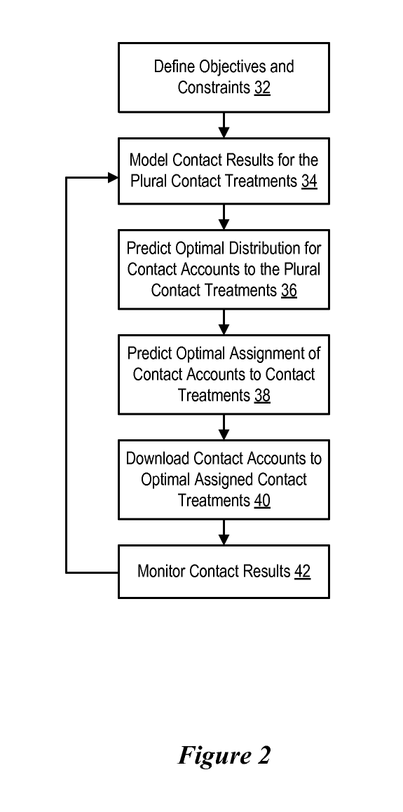

Referring now to FIG. 2, in operation, at step 32, the Gₖ values are set along with values for the weights for constraints and objective goal terms to perform simulations based on modeled contact results for the various distributions of contact treatments. For instance, a constrained optimization may set objective functions for the average daily inventory allowed, maximum expected cure percentage, specific expected cure percentage and total cost of treatment. For example, a requested solution might be to generate one or more treatment distribution scenarios for the best outcome in terms of cure while maintaining a specific average inventory to a dialing contact device. Alternatively, a requested solution might generate one or more treatment distribution scenarios that solve for a best outcome in terms of collection cost while maintaining a specific cure percentage. At step 34, contact results are predicted based on predictive models for each contact account and contact treatment. At step 36, an optimal distribution for the contact accounts to the plural contact treatments is established. For example a consideration is the relative expense of each contact treatment versus the likely results in terms of collections or account retention. In particular, excessive reliance on telephone communication treatment by queuing too many accounts can reduce the overall effectiveness by reducing the number of contact attempts for accounts that benefit more from telephone communication. At step 38, an optimal assignment of contact accounts to contact treatments is predicted. The predicted assignments are analyzed to provide user feedback, such as by outputting to the user statistics such as the total number of accounts and balances, the average balance, the distribution of accounts to treatments, the distribution of balances to treatments, the average balance with each treatment, the expected cure percentage for each treatment, the expected download to each treatment, the constraints used and the objectives solved. At step 40, the contact accounts are assigned to their assigned treatments. At step 42, the contact results for the treatments are monitored and provided as feedback at step 34 to maintain the currency of the proposed distributions for remaining or added accounts.

Although the present invention has been described in detail, it should be understood that various changes, substitutions and alterations can be made hereto without departing from the spirit and scope of the invention as defined by the appended claims.

What is claimed is:

1. A system for establishing contacts with plural accounts using plural treatments, the treatments including at least telephone communication, the system comprising:
a modeling module operable to model contact results to the plural accounts for contact attempts with the plural treatments;
an account inventory module operable to select some number less than all of the plural accounts for treatment by telephone communication; and
an optimizer module operable to apply plural constraints to optimize plural objectives based upon the modeled contact results, the optimizer module applying a goals programming formulation solving as an objective function at least the number of accounts to queue for telephone communication treatment.

2. The system of claim 1 wherein the plural treatments comprise a delayed contact treatment.

3. The system of claim 1 wherein the plural treatments comprise an electronic correspondence treatment.

4. The system of claim 1 wherein the plural treatments comprise a physical written correspondence treatment.

5. The system of claim 1 wherein the accounts comprise collection accounts and the objective functions comprise maximum cure rate.

6. The system of claim 1 wherein the accounts comprise collection accounts and the objective functions comprise minimum total cost.

7. The system of claim 1 wherein the accounts comprise collection accounts and the objective functions comprise maximum net revenue.

8. The system of claim 1 wherein the accounts comprise collection accounts and the objective functions comprise maximum balance weighted cures.

9. A method for establishing contacts with plural accounts using plural treatments, the treatments including at least telephone communication, the method comprising:
modeling contact results for contact attempts to the plural accounts with the plural treatments;
applying plural constraints to optimize plural objectives based upon the modeled contact results using a goals programming formulation solving as an objective function at least the number of accounts to download for telephone communication treatment; and
queuing the optimized number of accounts to a contact device for the telephone communication treatment.

10. The method of claim 9 further comprising:
monitoring contact results for contacts established by the contact device;
updating the accounts with the contact results; and
re-optimizing the plural objectives with the updated accounts to solve the number of accounts to queue for the telephone communication treatment.

11. The method of claim 9 wherein the plural treatments comprise a delayed contact treatment.

12. The method of claim 9 wherein the plural treatments comprise an electronic correspondence treatment.

13. The method of claim 9 wherein the plural treatments comprise a physical written correspondence treatment.

14. The method of claim 9 wherein the accounts comprise collection accounts and the objective functions comprise maximum cure rate.

15. The method of claim 9 wherein the accounts comprise collection accounts and the objective functions comprise minimum total cost.

16. The method of claim 9 wherein the accounts comprise collection accounts and the objective functions comprise maximum net revenue.

17. The system of claim 9 wherein the accounts comprise collection accounts and the objective functions comprise maximum balance weighted cures.

18. An optimizing system for coordinating a contact campaign, the contact campaign having plural accounts and plural contact treatments, the contact treatments for attempting to establish contacts with the accounts, the optimizing system comprising:
instructions stored on a storage medium, the instructions operable to run on a computer system to:
model contact results for contact attempts to the plural accounts with the plural treatments;
apply plural constraints to optimize plural objectives based upon the modeled contact results, plural objectives including at least the number of accounts to queue for telephone communication treatment; and
download the optimized number of accounts to one or more contact devices for the telephone communication treatment.

19. The optimizing system of claim 18 wherein the instructions are further operable to monitor contact results for contact attempts made by the contact device and to reapply the plural constraints to reoptimize the number of accounts to queue for telephone communication treatment.

20. The optimizing system of claim 18 wherein the instructions are further operable to solve the objective function using a goals programming formulation.
